(19) United States
(12) Patent Application Publication
(10) Pub. No.: US 2026/0101891 A1
(43) Pub. Date: Apr. 16, 2026

(54) Disinfectant Composition Containing Low Levels of an Antimicrobial Agent

(71) Applicant: Arxada AG, Visp (CH)

(72) Inventors: Heather Cottrell, Visp (CH); Neil Scott Shaw, Visp (CH); Aaron Thomas Arnold Nightingale, Visp (CH); Emma Cooban, Visp (CH); Oxana Cesuina, Visp (CH)

(21) Appl. No.: 19/114,819

(22) PCT Filed: Sep. 27, 2023
(86) PCT No.: PCT/EP2023/076725

§ 371 Date: Mar. 25, 2025

Related U.S. Application Data
(60) Provisional application No. 63/412,623, filed on Oct. 3, 2022.

(30) Foreign Application Priority Data
Nov. 11, 2022 (EP) 22201527.3

(51) Int. Cl. A01N 33/12; A01N 25/02; A01N 25/30; A01N 25/34; A01N 31/02; A01P 1/00; A01P 3/00

(52) U.S. Cl. CPC A01N 33/12; A01N 25/02; A01N 25/30; A01N 25/34; A01N 31/02; A01P 1/00; A01P 3/00

(57) ABSTRACT

A disinfectant composition that may be a ready to use solution or a liquid concentrate. The disinfectant composition comprises an antimicrobial agent and a surfactant. The antimicrobial agent comprises a quaternary ammonium compound or a mixture of quaternary ammonium compounds in low amounts. The surfactant comprises an ethoxylated secondary alcohol or a mixture of ethoxylated secondary alcohols.

### BACKGROUND

Pathogenic organisms, such as bacteria, fungi, and viruses, continue to cause infections in humans as well as domestic animals and pets. Disinfectant formulations have been developed over the last several decades to reduce or destroy pathogenic organisms and accordingly, reduce the rate of infection. Literally any hard surface including floors, walls, countertops, windows, windowsills, sinks, faucets, waste containers, appliances, and cabinet surfaces can become contaminated and pose a transmission risk to those that come into contact with these surfaces. Disinfectants have been developed to treat hard surfaces for use in hospitals, rest homes, schools, and homes.

A disinfectant refers to any chemical agent capable of killing, destroying, or inhibiting the growth of organisms, particularly microorganisms. Disinfectant products include hard surface cleaners, hand sanitizers, sterilizing compositions, and the like. Antimicrobial compositions for decontamination, disinfection and/or sanitization can also be added to wipes in order to treat such surfaces.

Ideally, a disinfectant has broad-spectrum activity against all types of microorganisms at various pH levels. The disinfectant should also have high efficacy so that a minimum amount of the antimicrobial agent can be used to save cost and to avoid or reduce any possible adverse effects caused by the antimicrobial agent. Also, it is desirable that the disinfectant is stable to any changes in temperature encountered during manufacturing, packaging, and shipping as well as during storage. Further, an ideal disinfectant is physically and chemically compatible with ingredients of different application systems so that the antimicrobial agent can suitably be incorporated in various products.

In the past, various different disinfectants have been suggested. For example, disinfectants that have been used in the past include alcohols such as isopropyl alcohol and ethanol, copper compounds, silver compounds, aldehydes, oxidizing agents such as sodium hypochlorite, and the like.

In addition to the above disinfectants, quaternary compounds have also been used in the past. Quaternary compounds, in certain applications, need to be used at relatively high concentrations in order to achieve desired efficacy. For example, when quaternary compounds are used with a surfactant, the concentration of quaternary compounds has to be increased to counteract the negative effects of a surfactant. Surfactants, generally, interfere with the disinfectant efficacy of quaternary compounds necessitating the use of even higher amounts of quaternary compounds to achieve desired efficacy. Adding relatively high concentrations of a quaternary compound to a product, however, can be problematic. For instance, not only is the quaternary compound expensive to manufacture and produce but can also be subject to various regulatory requirements. Consequently, a need exists for a disinfectant composition that is low in quaternary compounds yet provides the desired disinfectant effect.

### SUMMARY

In general, the present disclosure is directed to a composition having disinfectant properties, premoistened wiping products, and methods for destroying microorganisms on a surface. In accordance with the present disclosure, a disinfectant composition is disclosed that may be a ready to use solution or a liquid concentrate. The disinfectant composition comprises an antimicrobial agent and a surfactant. The antimicrobial agent comprises a quaternary ammonium compound (“QAC”) or a mixture of quaternary ammonium compounds in low amounts. The surfactant comprises an ethoxylated secondary alcohol or a mixture of ethoxylated secondary alcohols. Of particular advantage, the disinfectant composition of the present disclosure not only contains low amounts of quaternary ammonium compound but also demonstrates efficacious disinfecting performance against many hospital grade microorganisms and enveloped viruses, such as Vaccinia virus.

In one aspect, a disinfectant composition that may be a ready to use solution or a liquid concentrate comprises an antimicrobial agent comprising a quaternary ammonium compound or a mixture of quaternary ammonium compounds, the antimicrobial agent being present in the ready to use solution in an amount less than about 10,000 ppm, preferably in an amount less than about 5000 ppm, preferably in an amount less than about 4,000 ppm, and most preferably in an amount less than about 3,000 ppm. The disinfectant composition also contains a surfactant comprising an ethoxylated secondary alcohol or a mixture of ethoxylated secondary alcohols. The surfactant is present in the composition in relation to the antimicrobial agent at a weight ratio of from about 1:5 to about 5:1, preferably at a weight ratio of from about 1:3 to about 3:1, preferably at a weight ratio of from about 1:2 to about 2:1, and most preferably at a weight ratio of from about 0.75:1 to about 1:0.75The surfactant can be the only nonionic surfactant contained in the composition.

In one aspect, the disinfectant composition comprises the antimicrobial agent that is present in the composition in an amount less than about 3,000 ppm. In one aspect, the disinfectant composition is in a water-soluble pouch.

In one aspect, the disinfectant composition comprises the liquid concentrate that is fifty times more concentrated than the ready to use solution and contains the antimicrobial agent in an amount less than about 125,000 ppm, preferably twenty times more concentrated than the ready to use solution and contains the antimicrobial agent in an amount less than about 50,000 ppm, preferably ten times more concentrated than the ready to use solution and contains the antimicrobial agent in an amount less than about 25,000 ppm, and most preferably five times more concentrated than the ready to use solution and contains the antimicrobial agent in an amount less than about 12,500 ppm.

In one aspect, the disinfectant composition can further comprise another surfactant in combination with the ethoxylated secondary alcohol. Such further surfactant can be a polymer or hydrotrope, such as, for example, polypropylene glycol (PPG). In one aspect, the surfactant can further include polypropylene glycol. The disinfectant composition can comprise the surfactant that is present in the composition in relation to the antimicrobial agent at a weight ratio of from about 1:1 to about 1:3, such as from about 1:1.5 to about 1:2.5. In one aspect, the disinfectant composition as defined in any of the preceding claims does not contain any other antimicrobial agents.

In one aspect, the disinfectant composition can comprise an antimicrobial agent that is present in the ready to use solution in an amount of about 2,500 ppm and a surfactant that is present in the composition in relation to the antimicrobial agent at a weight ratio of about 1:1.

In one aspect, the disinfectant composition further comprises a chelating agent. In one aspect, the disinfectant composition comprises the chelating agent that is methylglycinediacetic acid.

In one aspect, the disinfectant composition can comprise an antimicrobial agent that is present in the ready to use solution in an amount of about 2,500 ppm, a surfactant that is present in the composition in relation to the antimicrobial agent at a weight ratio of about 1:1, and a chelating agent in an amount of about 1,250 ppm.

In one aspect, the disinfectant composition further contains a pH adjusting agent, the pH adjusting agent comprising an acid. In one aspect, the disinfectant composition comprises hydrochloric acid. In one aspect, the disinfectant composition comprises pH that is adjusted between about pH6 to about pH8.

In one aspect, the disinfectant composition comprises an ethoxylated secondary alcohol that contains a carbon chain having a carbon chain length of from about C6 to about C60, such as from about C8 to about C42, such as from about C10 to about C32. In one aspect, the disinfectant composition comprises the ethoxylated secondary alcohol that is unbranched. In one aspect, the disinfectant composition comprises the ethoxylated secondary alcohol that contains from about 2 moles to about 16 moles of ethylene oxide per mole of alcohol, such as from about 3 moles to about 12 moles of ethylene oxide per mole of alcohol.

In one aspect, the disinfectant composition comprises the antimicrobial agent that is present in the composition in an amount from about 500 ppm to about 4,000 ppm, the surfactant being present in an amount from about 750 ppm to about 1,800 ppm, the disinfectant composition further containing a chelating agent in an amount from about 800 ppm to about 3,500 ppm and a pH adjusting agent comprising an acid present in the composition in an amount from about 50 ppm to about 500 ppm, the remainder of the disinfectant composition comprising water.

In one aspect, the disinfectant composition comprises the disinfectant composition that demonstrates at least a 5 log reduction when tested against Staphylococcus aureus, Enterococcus hirae, or Pseudomonas aeruginosa according to Test EN 16615:2015 for a contact time of 60 seconds, at least a 4 log reduction when tested against Candida albicans according to Test EN 16615 for a contact time of 60 seconds, or at least a 4 log reduction when tested against enveloped viruses according to a modified Test EN 16615 for a contact time of 60 seconds. The modified EN 16615 method replicates the testing procedure of the EN 16615:2015—a quantitative test method for the evaluation of bactericidal and yeasticidal activity on non-porous surfaces with mechanical action employing wipes in the medical area (4-field test)-(phase 2, step 2)) evaluating the disinfectant efficacy against Vaccinia virus rather than bacteria or yeast. The viral enumeration method used is consistent with those defined in EN 14476 (2013)+A2 (2019) (Quantitative suspension test for the evaluation of virucidal activity in the medical area. (Phase 2/Step 1)).

In one aspect, the disinfectant composition comprises at least one quaternary ammonium compound that comprises at least one dimethyl dialkyl ammonium chloride. The disinfectant composition can comprise at least one quaternary ammonium compound that comprises didecyl dimethyl ammonium chloride. The disinfectant composition can comprise at least one quaternary ammonium compound that comprises octyl decyl dimethyl ammonium chloride, dioctyl, dimethyl ammonium chloride, and/or dodecyl dimethyl ammonium chloride. The disinfectant composition can comprise a mixture thereof.

In one aspect, the present disclosure is directed to a premoistened wiping product comprising a liquid absorbent substrate, and a disinfectant composition contained within the substrate, the disinfectant composition as defined herein. In one aspect, the premoistened wiping product comprises the liquid absorbent substrate that comprises a nonwoven web, the nonwoven web comprising a meltblown web, a coform web, a spunbond web, an airlaid web, an airlaced web, a hydroentangled web, a bonded carded web, or a laminate thereof. In one aspect, the premoistened wiping product comprises the liquid absorbent substrate that contains cellulose fibers. In one aspect, the premoistened wiping product comprises the liquid absorbent substrate that is apertured.

In one aspect, the present disclosure is directed to a method for destroying microorganisms on an adjacent surface comprising saturating a liquid absorbent substrate with a disinfectant composition, the disinfectant composition as defined herein and applying the saturated liquid absorbent substrate to a hard surface.

Other features and aspects of the present disclosure are discussed in greater detail below.

### BRIEF DESCRIPTION OF THE FIGURES

A full and enabling disclosure of the present disclosure is set forth more particularly in the remainder of the specification, including reference to the accompanying figures, in which:

FIG. 1 shows average cleaning efficacy;

FIG. 2A shows average gloss, measured at 20° C.;

FIG. 2B shows average haze;

FIG. 3A shows streaking comparison based on gloss data;

FIG. 3B shows streaking comparison based on haze data; and

FIG. 4 shows a concentration of QAC readily absorbed by wipes.

### DETAILED DESCRIPTION

It is to be understood by one of ordinary skill in the art that the present discussion is a description of exemplary aspects only and is not intended as limiting the broader aspects of the present disclosure.

The present disclosure is generally directed to a disinfectant composition that may be a ready to use solution or a liquid concentrate. The composition has numerous uses and applications. The present disclosure is also directed to premoistened wiping products. The disinfectant composition can be used in any suitable industry or field. For instance, the disinfectant composition may comprise an institutional product, a domestic product, or a healthcare product. The disinfectant composition, for instance, may comprise a hard surface disinfectant, a hand sanitizer, a sterilizing composition, a water-soluble pouch, and the like. The present disclosure is also directed to methods for destroying microorganisms on a surface. In accordance with the present disclosure, the disinfectant composition contains an antimicrobial agent and a surfactant whereby the antimicrobial agent works to destroy and kill many different types of microorganisms including viruses. Many disinfectant compositions, for instance, require high levels of quaternary ammonium compound to be effective disinfectants that pass the EN16615 and EN13727 tests. Also, standard non-ionic surfactants used in the industry have a negative effect on antimicrobial efficacy. The negative effect seen with standard surfactants are currently negated by using a higher QAC level or longer contact time. Of particular advantage, the disinfectant composition of the present disclosure is capable of controlling and killing many different types of microorganisms, including viruses, using low levels of QAC with minimal to no negative effect on antimicrobial efficacy that is generally caused by the use of surfactants.

For example, in one aspect, a disinfectant composition of the present disclosure demonstrates at least a 5 log reduction when tested against Staphylococcus aureus according to Test EN 16615 for a contact time of 30 seconds. A disinfectant composition of the present disclosure can demonstrate at least a 5 log reduction when tested against Staphylococcus aureus according to Test EN 16615 for a contact time of 45 seconds. A disinfectant composition of the present disclosure can demonstrate at least a 5 log reduction when tested against Staphylococcus aureus according to Test EN 16615 for a contact time of 60 seconds. A disinfectant composition of the present disclosure can demonstrate at least a 5 log reduction when tested against Staphylococcus aureus according to Test EN 16615 for a contact time of 75 seconds.

In one aspect, a disinfectant composition of the present disclosure demonstrates at least a 5 log reduction when tested against Enterococcus hirae according to Test EN 16615 for a contact time of 30 seconds. A disinfectant composition of the present disclosure can demonstrate at least a 5 log reduction when tested against Enterococcus hirae according to Test EN 16615 for a contact time of 45 seconds. A disinfectant composition of the present disclosure can demonstrate at least a 5 log reduction when tested against Enterococcus hirae according to Test EN 16615 for a contact time of 60 seconds. A disinfectant composition of the present disclosure can demonstrate at least a 5 log reduction when tested against Enterococcus hirae according to Test EN 16615 for a contact time of 75 seconds.

In one aspect, a disinfectant composition of the present disclosure demonstrates at least a 5 log reduction when tested against Pseudomonas aeruginosa according to Test EN 16615 for a contact time of 30 seconds. A disinfectant composition of the present disclosure can demonstrate at least a 5 log reduction when tested against Pseudomonas aeruginosa according to Test EN 16615 for a contact time of 45 seconds. A disinfectant composition of the present disclosure can demonstrate at least a 5 log reduction when tested against Pseudomonas aeruginosa according to Test EN 16615 for a contact time of 60 seconds. A disinfectant composition of the present disclosure can demonstrate at least a 5 log reduction when tested against Pseudomonas aeruginosa according to Test EN 16615 for a contact time of 75 seconds.

In one aspect, a disinfectant composition of the present disclosure demonstrates at least a 4 log reduction when tested against Candida albicans according to Test EN 16615 for a contact time of 30 seconds. A disinfectant composition of the present disclosure can demonstrate at least a 4 log reduction when tested against Candida albicans according to Test EN 16615 for a contact time of 45 seconds. A disinfectant composition of the present disclosure can demonstrate at least a 4 log reduction when tested against Candida albicans according to Test EN 16615 for a contact time of 60 seconds. A disinfectant composition of the present disclosure can demonstrate at least a 4 log reduction when tested against Candida albicans according to Test EN 16615 for a contact time of 75 seconds.

In one aspect, a disinfectant composition of the present disclosure demonstrates at least a 4 log reduction when tested against enveloped viruses according to a modified Test EN 16615 for a contact time of 30 seconds. A disinfectant composition of the present disclosure can demonstrate at least a 4 log reduction when tested against enveloped viruses according to a modified Test EN 16615 for a contact time of 45 seconds. A disinfectant composition of the present disclosure can demonstrate at least a 4 log reduction when tested against enveloped viruses according to a modified Test EN 16615 for a contact time of 60 seconds. A disinfectant composition of the present disclosure can demonstrate at least a 4 log reduction when tested against enveloped viruses according to a modified Test EN 16615 for a contact time of 75 seconds.

In general, the disinfectant composition of the present disclosure contains an antimicrobial agent comprising a quaternary ammonium compound or a mixture of quaternary ammonium compounds a quaternary ammonium and a surfactant. In one aspect, the antimicrobial agent is combined with a surfactant to kill and/or control one or more microorganisms. The antimicrobial agent and the surfactant in accordance with the present disclosure operate together in order to kill or inhibit the growth of the microorganism. More particularly, the antimicrobial agent and the surfactant, combined together in accordance with the present disclosure, have greater efficacy at a lower concentration of QAC than if QAC alone was present in the composition. The use of QAC and the surfactant of the present disclosure can enhance the activity of the composition against multiple microorganisms and pass passes EN16615, EN 13727, and modified EN16615 tests against bacteria, yeast, and viruses, respectively, with a contact time of 1 minute (60 seconds) under dirty medical and dirty inflow and infiltration (I&I) conditions.

Specifically, the EN 16615 test relates to chemical disinfectants and antiseptics and is a quantitative test method for the evaluation of bactericidal and yeasticidal activity on non-porous surfaces such as, for example, with mechanical action employing wipes in the medical area (4-field test). The EN 13727 relates to chemical disinfectants and antiseptics and is a quantitative suspension test for the evaluation of bactericidal activity in, for example, the medical area. The EN16615 test can also be used to test against viruses for a contact time of 60 seconds under, for example, dirty medical and dirty inflow and infiltration (I&I) conditions. Thus, the antimicrobial composition of the present disclosure can be used at lower concentrations of QAC and yet be effective against a range of microorganisms. Ultimately, an antimicrobial composition can be produced with a total concentration of antimicrobial agent that is relatively low while still providing robust antimicrobial properties. In one aspect, the EN 16615 method can be used to evaluate the disinfectant efficacy of the composition of the present disclosure against, for example, Vaccinia virus at a contact time, for instance, of 60 seconds.

Quaternary ammonium compounds, typically, comprise at least one quaternary ammonium cation with an appropriate anion. Quaternary ammonium compounds will generally have the general formula (1).

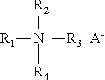

The groups R₁, R₂, R₃ and R₄ can vary within wide limits and examples of quaternary ammonium compounds that have antimicrobial properties will be well known to the person of ordinary skill in the art. Typically, two of R₁, R₂, R₃ and R₄ are lower alkyl, meaning having 1 to 4 carbon atoms, such as methyl, ethyl, propyl or butyl groups. In addition, two of R₁, R₂, R₃ and R₄ are longer chain alkyl groups of 6 to 24 carbon atoms, or a benzyl group. A⁻ is a monovalent anion or one equivalent of a polyvalent anion of an inorganic or organic acid. Suitable anions for A⁻ are in principle all inorganic or organic anions, in particular halides, for example chloride or bromide, carboxylates, sulfonates, phosphates or a mixture thereof.

In one aspect, the quaternary ammonium compound may have the following R groups: R₁ is benzyl or C₆₋₁₈-alkyl, R₂ is C₁₋₁₈-alkyl or —[(CH₂)₂—O]ₙR₅ where n=1-20, R₃ and R₄ independently of one another are C₁₋₄-alkyl, R₅ is hydrogen or unsubstituted or substituted phenyl, and A is a monovalent anion or one equivalent of a polyvalent anion of an inorganic or organic acid.

The quaternary ammonium compound may comprise a dialkyl ammonium compound, such as a dimethyl dialkyl ammonium compound. The dimethyl dialkyl ammonium compound may have between about 8 and about 12 carbon atoms, such as from about 8 to about 10 carbon atoms in each of the alkyl groups.

Examples of dimethyl dialkyl ammonium compounds which may be used as the antimicrobial agent include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used, and other anions, such as those described above, may also be used.

In one aspect, the quaternary ammonium compound may comprise dimethyl dialkyl ammonium chloride. The quaternary ammonium compound may comprise didecyl dimethyl ammonium chloride. The quaternary ammonium compound may comprise octyl decyl dimethyl ammonium chloride. The quaternary ammonium compound may comprise dioctyl dimethyl ammonium chloride (Bardac 2080).

In one aspect, the disinfectant composition may contain at least one quaternary ammonium compound that can comprise dimethyl dialkyl ammonium chloride. The disinfectant composition may contain at least one quaternary ammonium compound that can comprise didecyl dimethyl ammonium chloride. The disinfectant composition may contain at least one quaternary ammonium compound that can comprise octyl decyl dimethyl ammonium chloride, dioctyl dimethyl ammonium chloride, and didecyl dimethyl ammonium chloride.

In an alternative aspect, the antimicrobial agent may comprise a benzyl ammonium compound, such as an alkyl dimethyl benzyl ammonium compound. In general, the alkyl group may contain from about 10 to about 18 carbon atoms, such as from about 12 to about 16 carbon atoms.

Examples of alkyl dimethyl benzyl ammonium compounds useable as the antimicrobial agent include C₁₂ alkyl dimethyl benzyl ammonium chloride, C₁₄ alkyl dimethyl benzyl ammonium chloride, and C₁₆ alkyl dimethyl benzyl ammonium chloride. In addition, a mixture of these alkyl dimethyl benzyl ammonium compounds can be used. For instance, the alkyl dimethyl benzyl ammonium compounds may include blends of C₁₂, C₁₄, and C₁₆ alkyl dimethyl benzyl ammonium chlorides. Generally, the alkyl dimethyl benzyl ammonium compound, when a blend, can contain higher concentrations of C₁₂ alkyl and C₁₄ alkyl components than C₁₆ alkyl components. It is noted that other anions, including those mentioned above may also be used.

In one aspect, the antimicrobial agent may comprise a quaternary ammonium propionate. The quaternary ammonium propionate, for instance, may comprise a poly(oxyalkyl)ammonium propionate. In one particular aspect, for instance, the antimicrobial agent may comprise N, N-didecyl-N-methyl-poly(oxyethyl)ammonium propionate.

Alternatively, the antimicrobial agent can comprise a quaternary ammonium compound such as, for example, a quaternary ammonium carbonate. A quaternary ammonium carbonate can be represented by the following formula:

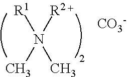

wherein R¹ is a C₁-C₂₀ alkyl or aryl-substituted alkyl group and R² is a C₈-C₂₀ alkyl group, and preferably wherein R¹ is the same as R² and R¹ is a C₈-C₁₂ alkyl group, as well as compositions further comprising the corresponding quaternary ammonium bicarbonate

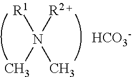

wherein R¹ is the same or a different C₁-C₂₀ alkyl or aryl-substituted alkyl group as above and R² is the same or a different C₈-C₂₀ alkyl group as above, but preferably wherein R¹ is the same as R² and R¹ is a C₈-C₁₂ alkyl group.

In one aspect, the antimicrobial agent contained in the composition comprises a di C₈-C₁₂ alkyl ammonium carbonate/bicarbonate. For example, in one particular aspect, the antimicrobial or preservative composition contains didecyl dimethyl ammonium carbonate and didecyl dimethyl ammonium bicarbonate.

In other aspect, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

In one aspect, the antimicrobial agent can be present in the ready to use solution in an amount range from about 1 ppm to about 10,000 ppm, including all increments of 1 ppm therebetween. In one aspect, the antimicrobial agent can, generally, be present in the ready to use solution in an amount less than about 9,500 ppm, such as in an amount of less than about 9,000 ppm, such as in an amount of less than about 8,500 ppm, such as in an amount of less than about 8,000 ppm, such as in an amount of less than about 7,500 ppm, such as in an amount of less than about 7,000 ppm, such as in an amount of less than about 6,500 ppm, such as in an amount of less than about 6,000 ppm, such as in an amount of less than about 5,500 ppm, such as in an amount of less than about 5,000 ppm, such as in an amount of less than about 4,500 ppm, such as in an amount of less than about 4,000 ppm, such as in an amount of less than about 3,500 ppm, such as in an amount of less than about 3,000 ppm, such as in an amount of less than about 2,500 ppm, such as in an amount of less than about 2,000 ppm, such as in an amount of less than about 1,500 ppm, such as in an amount of less than about 1,000 ppm, such as in an amount of less than about 500 ppm, such as in an amount of less than about 400 ppm, such as in an amount of less than about 350 ppm, such as in an amount of less than about 325 ppm, such as in an amount of less than about 300 ppm, such as in an amount of less than about 250 ppm, such as in an amount of less than about 200 ppm, such as in an amount of less than about 170 ppm, such as in an amount of less than about 160 ppm, such as in an amount of less than about 150 ppm, or such as in an amount of less than about 100 ppm.

In another aspect, the antimicrobial agent can be present in the ready to use solution in an amount greater than about 1 ppm, in an amount greater than about 10 ppm, in an amount greater than about 50 ppm, in an amount greater than about 100 ppm, in an amount greater than about 150 ppm, in an amount greater than about 200 ppm, in an amount greater than about 250 ppm, in an amount greater than about 300 ppm, in an amount greater than about 350 ppm, in an amount greater than about 400 ppm, in an amount greater than about 450 ppm, in an amount greater than about 500 ppm, in an amount greater than about 550 ppm, in an amount greater than about 600 ppm, in an amount greater than about 650 ppm, in an amount greater than about 800 ppm, in an amount greater than about 900 ppm, in an amount greater than about 1,000 ppm, in an amount greater than about 1,250 ppm, in an amount greater than about 1,500 ppm, in an amount greater than about 1,750 ppm, in an amount greater than about 2,000 ppm, in an amount greater than about 2,250 ppm, in an amount greater than about 2,500 ppm, in an amount greater than about 2,750 ppm, in an amount greater than about 3,000 ppm, in an amount greater than about 3,500 ppm, in an amount greater than about 4,000 ppm, in an amount greater than about 4,500 ppm, in an amount greater than about 5,000 ppm, in an amount greater than about 5,500 ppm, in an amount greater than about 6,000 ppm, in an amount greater than about 6,500 ppm, in an amount greater than about 7,000 ppm, in an amount greater than about 7,500 ppm, in an amount greater than about 8,000 ppm, in an amount greater than about 8,500 ppm, in an amount greater than about 9,000 ppm, or in an amount greater than about 9,500 ppm.

In yet another aspect, the antimicrobial agent can be present in the ready to use solution in an amount of about 100 ppm, in an amount of about 150 ppm, in an amount of about 200 ppm, in an amount of about 300 ppm, in an amount of about 600 ppm, in an amount of about 800 ppm, in an amount of about 1,000 ppm, in an amount of about 1,250 ppm, in an amount of about 1,500 ppm, in an amount of about 2,000 ppm, in an amount of about 2,500 ppm, in an amount of about 3,000 ppm, in an amount of about 4,000 ppm, in an amount of about 5,000 ppm, in an amount of about 6,000 ppm, in an amount of about 7,000 ppm, in an amount of about 8,000 ppm, in an amount of about 9,000 ppm, or in an amount of about 10,000 ppm.

In one aspect, the antimicrobial agent in the disinfectant composition can be present in a concentration that is two times more concentrated than the ready to use solution. The antimicrobial agent in the disinfectant composition can be present in a concentration that is three times more concentrated than the ready to use solution. The antimicrobial agent in the disinfectant composition can be present in a concentration that is four times more concentrated than the ready to use solution. The antimicrobial agent in the disinfectant composition can be present in a concentration that is five times more concentrated than the ready to use solution. The antimicrobial agent in the disinfectant composition can be present in a concentration that is six times more concentrated than the ready to use solution. The antimicrobial agent in the disinfectant composition can be present in a concentration that is ten times more concentrated than the ready to use solution. The antimicrobial agent in the disinfectant composition can be present in a concentration that is twenty times more concentrated than the ready to use solution. The antimicrobial agent in the disinfectant composition can be present in a concentration that is fifty times more concentrated than the ready to use solution.

In one aspect, the antimicrobial agent can be present in the liquid concentrate, as described above, in an amount less than about 36,000 ppm, including all increments of 1 ppm therebetween. In one aspect, the antimicrobial agent can, generally, can be present in the liquid concentrate, as described above, in an amount less than about 30,000 ppm, such as in an amount less than about 25,000 ppm, such as in an amount less than about 20,000 ppm, such as in an amount less than about 15,000 ppm, such as in an amount less than about 12,500 ppm, such as in an amount less than about 12,500 ppm, such as in an amount less than about 10,000 ppm, such as in an amount less than about 7,500 ppm, such as in an amount less than about 5,000 ppm, such as in an amount less than about 2,500 ppm, or such as in an amount less than about 1,000 ppm.

For example, in one aspect, the liquid concentrate can be two times more concentrated than the ready to use solution and can contain the antimicrobial agent in an amount less than about 5,000 ppm. The liquid concentrate can be three times more concentrated than the ready to use solution and can contain the antimicrobial agent in an amount less than about 7,500 ppm. The liquid concentrate can be four times more concentrated than the ready to use solution and can contain the antimicrobial agent in an amount less than about 10,000 ppm. The liquid concentrate can be five times more concentrated than the ready to use solution and can contain the antimicrobial agent in an amount less than about 12,500 ppm. The liquid concentrate can be six times more concentrated than the ready to use solution and can contain the antimicrobial agent in an amount less than about 15,000 ppm. The liquid concentrate can be ten times more concentrated than the ready to use solution and contains the antimicrobial agent in an amount less than about 25,000 ppm. The liquid concentrate can be twenty times more concentrated than the ready to use solution and contains the antimicrobial agent in an amount less than about 50,000 ppm. The liquid concentrate can be fifty times more concentrated than the ready to use solution and contains the antimicrobial agent in an amount less than about 125,000 ppm.

In one aspect, any other antimicrobial agent may be substantially absent from the disinfectant composition. For example, the disinfectant composition may not contain any other antimicrobial agents. In one aspect, a disinfectant composition that may be a ready to use solution or a liquid concentrate comprising an antimicrobial agent comprising a quaternary ammonium compound or a mixture of quaternary ammonium compounds, a surfactant comprising an ethoxylated secondary alcohol or a mixture of ethoxylated secondary alcohols, and no other antimicrobial agent. In one aspect, the remainder of the disinfectant composition can comprise water. Water can generally be present in the concentrate in an amount from about 10% to about 80% by weight, such as in an amount from about 30% to about 70% by weight.

In one aspect, the composition of the present disclosure may include a surfactant. Typically, the surfactant will be a nonionic surfactant or a cationic surfactant. A surfactant can be a secondary alcohol surfactant, such as an ethoxylated secondary alcohol. As described herein, the composition of the present disclosure contains a particular type of a surfactant that has been surprisingly found to preserve the disinfectant efficacy of the quaternary ammonium compounds.

In one aspect, the surfactant can comprise an ethoxylated secondary alcohol or a mixture of ethoxylated secondary alcohols. The ethoxylated alcohol, for instance, may comprise an ethoxylated C₁₂ to C₁₄ alkyl alcohol. The ethoxylated secondary alcohol may contain a carbon chain having a carbon chain length of from about C6 to about C60, such as from about C8 to about C42, such as from about C10 to about C32, such as about C8 to about C22, such as about C6 to about C12. The secondary alcohol contained in the ethoxylated secondary alcohol can be unbranched. In another aspect, the secondary alcohol contained in the ethoxylated secondary alcohol can be branched. The ethoxylated secondary alcohol can contain from about 2 moles to about 16 moles of ethylene oxide per mole of alcohol, such as from about 3 moles to about 12 moles of ethylene oxide per mole of alcohol, such as from about 4 moles to about 8 moles of ethylene oxide per mole of alcohol, such as from about 2 moles to about 4 moles of ethylene oxide per mole of alcohol.

Exemplary commercially available nonionic surfactants are C11-C15 secondary alkanols condensed with 5, 7, 9, 12, 20, or 40 moles of ethylene oxide (alkyloxypolyethylene oxyethanols), produced by Dow Chemical under the tradenames Tergitol® 15-S-7, 15-S-9, 15-S-12, 15-S-20, and 15-S-40. In one aspect, the surfactant may comprise secondary ethoxylated alcohols and polyethylene oxide, commercially sold as Tergitol™ 15 S-5. Additional exemplary nonionic surfactants, of the same type, are marketed by Dow Chemical under the tradenames Tergitol® TMN-6 and TMN-10, believed to comprise reaction products of trimethyl-nonanol with ethylene oxide. Other exemplary nonionic surfactants are commercially available from BASF under the tradename Irgasurf® HL 560. Still other nonionic surfactants include block copolymers of polyoxyethylene and polyoxypropylene that are available under the trade name Pluronic®, marketed by BASF. A single member of any of the foregoing nonionic surfactant compositions can be used in the wiping composition, or mixtures of such exemplary nonionic surfactant materials can be employed.

In another aspect, a nonionic surfactant, can include compounds produced by the condensation of a hydrophilic alkylene oxide group with an aliphatic or alkyl aromatic hydrophobic compound. Examples of classes of nonionic surfactants are: Long chain tertiary amine oxides corresponding to the following general formula:

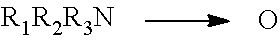

wherein R₁ contains an alkyl, alkenyl or monohydroxy alkyl radical of from about 8 to about 18 carbon atoms, up to about 10 ethylene oxide moieties, and up to 1 glyceryl moiety, and R₂ and R₃ contain from 1 to about 3 carbon atoms and up to about 1 hydroxy group, e.g., methyl, ethyl, propyl, hydroxyethyl, or hydroxypropyl radicals. Examples of amine oxides suitable for use in this invention include: dimethyldodecylamine oxide, oleyldi(2-hydroxyethyl)amine oxide, dimethyloctylamine oxide, dimethyldecylamine oxide, dimethyltetradecylamine oxide, di(2-hydroxyethyl)tetradecylamine oxide, 3-dodecoxy-2-hydroxypropyldi(3-hydroxypropyl)amine oxide, and dimethylhexadecylamine oxide.

In one aspect, the polyethylene oxide condensates of alkyl phenols, e.g., the condensation products of alkyl phenols having an alkyl group containing from about 6 to 12 carbon atoms in either a straight chain or branched chain configuration, with ethylene oxide, the said ethylene oxide being present in amounts equal to 6 to 60 moles of ethylene oxide per mole of alkyl phenol. The alkyl substituent in such compounds may be derived from polymerized propylene, diisobutylene, octane, or nonane.

In another aspect, those derived from the condensation of ethylene oxide with the product resulting from the reaction of propylene oxide and ethylene diamine products which may be varied in composition depending upon the balance between the hydrophobic and hydrophilic elements which is desired. For example, compounds containing from about 40% to about 80% polyoxyethylene by weight and having a molecular weight of from about 5,000 to about 11,000 resulting from the reaction of ethylene oxide groups with a hydrophobic base constituted of the reaction product of ethylene diamine and excess propylene oxide, said base having a molecular weight of the order of 2,500 to 3,000, are satisfactory. The condensation product of straight or branched chain aliphatic alcohols having from 8 to 18 carbon atoms with ethylene oxide, e.g., a coconut alcohol ethylene oxide condensate having from 10 to 30 moles of ethylene oxide per mole of coconut alcohol, the coconut alcohol fraction having from 10 to 14 carbon atoms.

In one aspect, particular surfactants that may be used in the composition are nonyl phenol ethoxylates (6-12 moles), primary alcohol ethoxylates (3-12 moles), and secondary alcohol ethoxylates (3-12 moles). Particularly suitable surfactants can be alkoxylated alcohol surfactant which generally have between about 2 to about 8 moles of alkoxylation. Typically, there will be between 3 and 6 moles of alkoxylation. One particular example is about 4.5 moles of alkoxylation. In addition to having the degree of alkoxylation, the alcohol which is alkoxylate will be a Ce—C₁₂ alkyl alcohol. In one aspect, the alkyl alcohol is a Cs—C₁₀ alkyl alcohol. The alkoxylation may be ethoxylation. Generally, it is desirable to have the HLB (hydrophilic-lipophilic balance) to be in the range of 8-14, and more generally between 10 and 12, for example about 11.

In one aspect, the non-ionic surfactants that may be used in the present disclosure include, but are not limited to, polyoxyethylene glycol alkyl ethers, octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, polyoxyethylene glycol alkylphenol ethers, glycerol alkyl esters, polyglycerol esters, glyceryl laurate, polyoxyethylene glycol sorbitan alkyl esters, sorbitan alkyl esters, dodecyldimethylamine oxide, block copolymers of polyethylene glycol and polypropylene glycol, poloxamers and polyethoxylated tallow amine (POEA), and mixtures thereof.

In one aspect, the only nonionic surfactant present is an ethoxylated secondary alcohol. Alternatively, one or more other surfactants may be present in the disinfectant composition of the present disclosure. For example, the composition can contain another surfactant in combination with the ethoxylated secondary alcohol. Such another surfactant can be a polymer or hydrotrope, such as, for example, polypropylene glycol (PPG). Another nonionic surfactant that may, additionally, be present with an ethoxylated secondary alcohol in the disinfectant composition is a glycoside. For instance, the glycoside may comprise D-glucopyranose, oligomeric, decyl octyl glycosides.

In one aspect, the amount of the nonionic surfactant in a ready to use solution in relation to the antimicrobial agent can be at a weight ratio from about 1:5 to about 5:1, such as from about 1:4 to about 4:1, such as from about 1:3 to about 3:1, such as from about 1:2 to about 2:1, such as from about 1:1, such as from about 1:1 to about 1:2, such as from about 1:1 to about 1:3, such as from about 1:1 to about 1:4, such as from about 1:1 to about 1:5, such as from about 0.75:1 to about 1:0.75, such as from about 1:1.5 to about 1:2.5, such as from about 1:2.5 to about 1:3.5, or such as from about 1:3.5 to about 1:4.5.

In another aspect, the surfactant can be present in the ready to use solution in an amount range from about 400 ppm to about 4,000 ppm, including all increments of 1 ppm therebetween. In one aspect, the surfactant can, generally, be present in an amount from about 500 ppm to about 3,500 ppm, such as in an amount from about 600 ppm to about 3,000 ppm, such as in an amount from about 700 ppm to about 2,000 ppm, such as in an amount from about 750 ppm to about 1,800 ppm, such as in an amount from about 800 ppm to about 1,600 ppm, such as in an amount from about 850 ppm to about 1,400 ppm, or such as in an amount from about 900 ppm to about 1,200 ppm.

In one aspect, the amount of the nonionic surfactant in a liquid concentrate can be the same ratio as described above in relation to the ready to use solution. For example, a liquid concentrate may contain a higher total amount of the antimicrobial agent and a higher total amount of a surfactant whilst the ratio between the antimicrobial agent and the surfactant remains the same as in the ready to use solution.

The inventors of the present disclosure unexpectedly discovered that low QAC levels, as described herein, can be used and still provide excellent efficacy against all different types of microorganisms when the surfactant used is an ethoxylated secondary alcohol. It was discovered that the ethoxylated secondary alcohol as a surfactant unexpectedly has none to minimal negative effect on the antimicrobial efficacy. In tun, QAC levels required to achieve desired disinfectant efficacy do not have to be increased to counteract any negative effects that are, generally, associated with standard non-ionic surfactants used in the industry. Dramatically and unexpectedly, the disinfectant composition of the present disclosure achieves antimicrobial efficacy while using lower QAC levels along with this particular surfactant, thereby providing for increased safety benefits.

In one aspect, the antimicrobial agent, as described above, can be, optionally, combined with a preservative, in accordance with the present disclosure. The preservative acts as an adjuvant for the antimicrobial agent and, for example, serves to inhibit any microbial growth in the disinfectant composition. In another aspect, the antimicrobial agent, as described above, can contain no preservative. Suitable preservatives can include water soluble preservatives. For example, benzisothiazolinone, methylbenzisothiazolinone, butylbenzisothiazolinone, methylisothiazolinone, chlormethylisothiazolinone, octylisothiazolinone, benzoic acid or salts thereof, sorbic acids or salts thereof, lactic acid or salts thereof, DMDM hydantoin, 2,2-dibromo-3-nitrilopropionamide, phenoxyethanol, benzyl alcohol, 3-iodo-2-propynylbutylcarbamate, Biphenyl-2-ol, Bronopol, Chlorocresol, ethanol, isopropranol, formic acid or salts thereof, hydrogen peroxide, N-(3-aminopropyl)-N-dodecylpropane-1,3-diamine, peracetic acid, sodium pyrithione, zinc pyrithione.

In one aspect, the disinfectant composition may further, optionally, contain a chelating agent. Suitable chelating agents include, but are not limited to, ethylene diamine tetra acetic acid (EDTA) and salts thereof (e.g., tetrasodium EDTA available as Versene 100® from Dow Europe S.A. of Horgen, Switzerland), diammonium ethylene diamine tetraacetate, aminocarboxylic acids, amino phosphonic acids, fatty acid salts, mixtures thereof, and the like. Amino phosphonic acids include ethylene diaminetetramethylene phosphonic acid, diethylene triamine penta (methylene phosphonic acid), ethylene diamine tri (methylene phosphonic acid), and hexamethylene diaminetetra(methylene phosphonic acid). In general, suitable chelating agents include methylglycinediacetic acid (MGDA), glutamic acid, N,N-diacetic acid (GLDA), iminodisuccinic acid (IDS); ethylenediaminetetraacetic acid (EDTA) diethylenetriaminepentaacetic acid (DTPA), diethylenethamine-penta-methylene phosphonic acid (DETPMP), hydroxyethyliminodiacetic acid (HEIDA), Nitrilothacetic acid (NTA), aspartic acid diethoxysuccinic acid (AES), aspartic acid-N,N-diacetic acid (ASDA), diethylenethaminepentamethylene-phosphonic acid (DTPMPA), hydroxyethylenediaminetetraacetic acid (HEDTA), hydroxyethylethylenediaminetriacetic acid (HEEDTA), iminodifumaric (IDF), iminoditartahc acid (IDT), iminodimaleic acid (IDMAL), iminodimalic acid (IDM), ethylenediaminedifumaric acid (EDDF), ethylenediaminedimalic acid (EDDM), ethylenediamineditartahc acid (EDDT), ethylenediaminedimaleic acid and (EDDMAL), aminotri(methylenephosphonic acid) (ATMP). In one aspect, the chelating agent is selected from iminodisuccinic acid (IDS), ethylenediaminetetraacetic acid (EDTA) diethylenetriaminepentaacetic acid (DTPA), hydroxyethylenediaminetetraacetic acid (HEDTA), hydroxyethylethylenediaminetriacetic acid (HEEDTA), iminodifumaric (IDF), iminoditartaric acid (IDT), iminodimaleic acid (IDMAL), iminodimalic acid (IDM), ethylenediaminedifumaric acid (EDDF), ethylenediaminedimalic acid (EDDM), ethylenediamineditartaric acid (EDDT), ethylenediaminedimaleic acid (EDDMAL) and aminotri(methylenephosphonic acid) (ATMP). In one aspect, chelating agent can be citric acid, nitriloacetic acid, various phosphoric acids and zeolites, and other agent that serve to remove hardness from the water used as the solvent.

The ability of the chelating agent to remove metal ions facilitates of the solution by preventing hardness (calcium) precipitation. The chelating agent may also serve to bind other metal ions that may adversely affect the effectiveness of the disinfecting components in the composition.

In one aspect, the chelating agent is present in the disinfectant composition in an amount of from about 500 ppm to about 5,000 ppm, including all increments of 1 ppm therebetween. In one aspect, the chelating agent can, generally, be present in an amount of from about 600 ppm to about 4,500 ppm, such as in an amount of from about 700 ppm to about 4,000, such as in an amount of from about 800 ppm to about 3,500 ppm, such as in an amount of from about 900 ppm to about 3,000 ppm, or such as in an amount of from about 1,000 ppm to about 2,500 ppm.

In one aspect, the disinfectant product may further contain a pH adjusting agent. Suitable pH adjusting agents include sodium hydroxide, sodium citrate, and other similar compounds. In one aspect, the pH adjusting agent may comprise an acid. The pH adjusting agent in the disinfectant composition may be hydrochloric acid. In one aspect, the ready to use solution and the liquid concentrate containing the disinfectant composition can have a pH in the range of about pH5 to about pH13. In one aspect, the ready to use solution and the liquid concentrate containing the disinfectant composition can have a pH in the range of about pH6 to about pH8. Generally, the disinfectant composition will be considered a neutral disinfecting composition if the pH is in the range of about pH6 to about pH8. The disinfectant composition will be considered an alkaline disinfectant composition when the pH is in the range of above pH8 to about pH12. The ready to use solution and the liquid concentrate containing the disinfectant composition can be a neutral or an alkaline disinfectant composition.

In one aspect, the pH adjusting agent is present in the disinfectant composition in an amount of from about 25 ppm to about 1,000 ppm, including all increments of 1 ppm therebetween. In one aspect, the pH adjusting agent can, generally, be present in an amount of from about 30 pm to about 900 ppm, such as in an amount of from about 35 ppm to about 800 ppm, such as in an amount of from about 40 ppm to about 700 ppm, such as in an amount of from about 45 ppm to about 600 ppm, such as in an amount of from about 50 ppm to about 500 ppm, such as in an amount of from about 55 ppm to about 400 ppm, such as in an amount of from about 60 ppm to about 300 ppm, such as in an amount of from about 65 ppm to about 200 ppm, or such as in an amount of from about 70 ppm to about 100 ppm.

In another aspect, the disinfectant composition of the present disclosure can be used in numerous and different products. For instance, the disinfectant composition can be incorporated into a hard surface cleaner, a hand sanitizer, a disinfectant solution, including solution for instruments such as medical instruments, or in any other suitable disinfectant product. The disinfectant product may be used, for instance, to clean hard surfaces and/or to sterilize instruments. In general, the disinfectant composition of the present disclosure can be incorporated into any suitable disinfectant product.

When used as a hard surface cleaner, the disinfectant composition can be delivered to a surface to be cleaned, sanitized or disinfected by conventional means such as pouring the composition on a surface, a spray, which is applied to a surface via a spray means, including but not limited to, pump spray applicators, pressurized spray applicators and the like; a saturated wipe; a rag and a bucket; a mop and bucket; a sponge and a bucket; or via automated cleaning equipment and other similar and conventional ways to apply a disinfectant composition to a surface for the purposes of sanitizing or disinfecting the surface.

To use the disinfectant composition of the present disclosure, a surface can be treated by spraying, pouring, wiping or otherwise applying the antimicrobial composition to the surface. Once applied to the surface, the disinfectant composition can be allowed to remain on the surface for a period of time. The antimicrobial composition may be applied to the surface and allowed to dry or may alternatively be dried by wiping the surface with, for example, a dry wipe or wiping device.

Surfaces, which may be disinfected with the disinfectant composition include, but are not limited to, those located in dairies, homes, health care facilities, swimming pools, canneries, food processing plants, restaurants, hospitals, institutions, and industry, including secondary oil recovery. Hard surfaces, such as glass and polished aluminum, are particularly suited for application. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The disinfectant composition can also be used to sanitize floors, walls, furniture, mirrors, toilet fixtures, windows, and wood surfaces, such as fence rails, porch rails, decks, roofing, siding, window frames, and door frames. The disinfectant composition can be suited for application on indirect food contact surfaces, such as cutting boards, utensils, containers, dishes, wash basins, appliances, and countertops. The disinfectant composition can be used to sanitize dairy plant equipment, milking machines, milk pails, tank trucks, and the like. Areas in hospitals would include beds, gurneys, tables, canisters, toilets, waste cans, stands, cabinets, shower stalls, floors, walls or any other non-porous surface.

In addition to a hard surface cleaner, as described above, disinfectant composition can also be incorporated into a hand sanitizer or a sterilization solution. When in a form of a solution, the disinfectant composition can be a ready to use solution or a liquid concentrate of the ready to use solution.

In one aspect, the disinfectant composition can be in a form of a water-soluble pouch such as, for example, water-soluble pods, water-soluble film enclosures, water-soluble capsules, or the like. The water-soluble pouch can be made of any suitable material that is soluble in water. For example, it can include the films made from polyvinyl alcohol, soy-based films, any other non-toxic water-soluble films suitable for enclosing the disinfectant composition of the present disclosure. The pouch can be manufactured by any suitable method including, for example, thermoforming the film.

In one aspect, a useful application is impregnating the disinfectant composition into a wipe substrate. In one aspect, the wipe is a single use wipe that is impregnated with the disinfectant composition and is stored in a container that will dispense the wipe to a user. The container with the wipes may contain a single wipe, or several wipes. Suitable containers include a pouch containing a single wipe, such as a moist towelette which is torn open by the user, or may be a pouch with a resealable opening containing several wipes in a stacked fashion, a rolled fashion or other suitable formation that would allow a single wipe to be removed from the opening at a time. Pouches are generally prepared form a fluid impervious material, such as a film, a coated paper or foil or other similar fluid impervious materials. In another way to dispense wipes of the present invention is to place the wipe into a fluid impervious container having an opening to access the wipes in the container. Containers may be molded plastic container with lids that are fluid impervious. Generally, the lid will have an opening to access the wipes in the container. The wipe in the container may be in a interleaved stacked, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

Disposable wipes provide advantages over other application vehicles, such as a reusable sponge, rag or the like. Unlike sponges, rags and the like, which are used repeatedly, the impregnated wipe is used a single time and disposed of. Reused sponge or rag presents problems since the sponge or rags may carry microbes that are not easily killed by the disinfecting composition. Further, the disinfecting composition is formulated to treat hard surface, not porous soft surfaces that are present in sponges or rags.

The disinfectant composition can be impregnated into the wipe such that the wipe is pre-moistened and will express or release the disinfecting composition on to the surface as the wipe is run across the surface to be treated. Generally, the disinfecting composition is saturated into the wipe such that the wipe will release the disinfecting composition to the surface through the wiping action. Depending on the wipe substrate, saturation can, generally, be achieved using about 3 wt parts of the use disinfecting composition per 1 wt part of the wipe substrate to be saturated. Generally, the disinfecting composition is used from about 4 parts to 6 parts by weight per 1 part by of the wiper substrate. In these ranges, complete saturation of the substrates can be achieved. It is noted that the amount of the disinfecting solution may go up or down to achieve complete saturation of the wipe substrate, depending on the particular wipe substrate.

In one aspect, the disinfectant composition may be well suited for saturating wipes and using the wipes to disinfect various surfaces. In one aspect, the disinfectant composition may be used in a premoistened wiping product. The premoistened wiping product can contain an antimicrobial agent, an antimicrobial agent blended with water, an antimicrobial agent blended with a preservative, an antimicrobial agent blended a surfactant, an antimicrobial agent blended a chelating agent, an antimicrobial agent blended pH adjusting agent, or any combination thereof.

In general, the premoistened wiping product of the present disclosure contains a quaternary ammonium compound, as detailed above. In one aspect, the premoistened wiping product comprises a liquid absorbent substrate. In one aspect, the premoistened wiping product contains a disinfectant composition, as detailed above. The disinfectant composition contained within the substrate can comprise at least one of the following: an antimicrobial agent, a preservative, a surfactant, a chelating agent, a pH adjusting agent, an aqueous solution, such as water, or any combination thereof, as detailed above.

Suitable wipe substrates include woven and nonwoven materials. In one aspect, the liquid absorbent substrate can comprise a nonwoven web. The nonwoven web can comprise a meltblown web, a coform web, a spunbond web, an airlaid web, an airlaced web, a hydroentangled web, a bonded carded web, or a laminate thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more. In one aspect, the liquid absorbent substrate in the premoistened wiping product may contain cellulose fibers. In one aspect, the liquid absorbent substrate in the premoistened wiping product may be apertured.

In one aspect the wipe is impregnated with a disinfectant composition containing both active and inert ingredients within the allowable tolerance levels and the wiping composition expressed from the wipe contains active ingredients within the allowable tolerance levels. Once applied to the surface, the antimicrobial premoistened wiping product is allowed to remain on the surface for a period of time.

For example, in one aspect, the nonionic surfactants described herein are selected to adsorb or otherwise bond to the fibers of a dry substrate of the premoistened wiping product, thereby preventing the active disinfectants from being adsorbed by the fibers of the dry substrate. Without being bound by theory, it is believed that the nonionic surfactants described herein alter the relative equilibrium at the premoistened wiping product surface by both modifying the surface to make it less hydrophobic and modifying the wiping composition to make it less hydrophilic. For example, in the case of a QAC solution, such as that including a dialkyl or alkyl benzyl quaternary solution, the net result is a reduced attraction of the hydrophobic wiper surface for the hydrophobic hydrocarbon tails of the disinfectant composition solution. The hydrophobic groups have an affinity for the fiber surface of the substrate. Unlike anionic surfactants, the nonionic nature of the surfactant does not attract the cationic quat-based or chlorine-based disinfectant solutions and prevents the active disinfectant from bonding to the substrate fibers. Various nonionic surfactants, as detailed above, may be present in the premoistened wiping product.

In one aspect, the premoistened wiping product may, optionally, further contain corrosion inhibitors, complexing agents, auxiliaries, preservatives, fragrances, colorants and the like. Exemplary corrosion inhibitors include, for example, organic phosphorous compounds and blend of organic phosphorous compounds with a polymeric component. Exemplary auxiliaries include, for example, polyethylene glycol or other similar compounds. Colorants and fragrances may be added provided they do not interfere with the function of the composition and may serve for identifying the composition. Generally, the optional further ingredients will make up less than about 20% by weight of the composition. For example, each of the above identified ingredients or components can be present in the composition generally in an amount from about 0.01% by weight to about 5% by weight. For instance, each of the above components can be present in the composition in an amount from about 0.1% to about 2% by weight, such as from about 0.3% to about 1% by weight.

The premoistened wiping product of the present disclosure can be supplied comprising a ready to use solution composition. In one aspect, the premoistened wiping product can contain the antimicrobial agent which can comprise a quaternary ammonium compound and a surfactant, as described herein. In alternative aspect, the premoistened wiping product can also, optionally, contain at least one or more of additional surfactant, preservative, pH adjusting agents, chelating agent, or water.

Various different microorganisms may be killed or controlled in accordance with the present disclosure, as detailed above. For instance, the wiping composition of the present disclosure can control gram positive bacteria, gram negative bacteria, and the like. In addition to bacteria, the antimicrobial composition of the present disclosure can also kill and control the growth of various other microorganisms, such as fungi, spores, yeast, mycobacteria, viruses and the like.

In one aspect the present disclosure is directed to a method for destroying microorganisms on an adjacent surface. The method can comprise saturating a liquid absorbent substrate with a disinfectant composition. In one aspect, the disinfectant composition that is saturated into a liquid absorbent substrate can be applied to a hard surface. The method for disinfecting an adjacent object can comprise blending an antimicrobial agent with a surfactant. The method can comprise reducing various microorganisms and viruses on a surface, detailed above.

The present disclosure may be better understood with reference to the following example. The following examples are intended to provide a more complete understanding of the present invention and are not intended, however, to limit the invention.

### EXAMPLES

### Example No. 1

Various different disinfectant compositions were tested for efficacy against various microorganisms.

In Table 1, formulations for each composition tested are provided.

TABLE 1
Sample Formulations.

| Formulation | |
|---|---|
| Sample No. | Formulation |
| Comparative | 100 g of the solution contains 0.25 g didecyl dimethyl ammonium |
| Sample No. 1 | chloride + 0.5 g alkyl (C12-16) dimethyl benzyl ammonium chloride |
| | (100 g of the solution contains 2,500 ppm didecyl dimethyl ammonium |
| | chloride + 5,000 ppm alkyl (C12-16) dimethyl benzyl ammonium |
| | chloride) |
| Formulation | 625 ppm quaternary disinfectant (demineralized water, octyl decyl |
| Sample No. 2 | dimethyl ammonium chloride, and dioctyl dimethyl ammonium |
| | chloride) + 1,250 ppm surfactant (secondary ethoxylated alcohols and |
| | polyethylene oxide) |
| Formulation | 1,250 ppm quaternary disinfectant (demineralized water, octyl decyl |
| Sample No. 3 | dimethyl ammonium chloride, and dioctyl dimethyl ammonium |
| | chloride) + 1,250 ppm surfactant (secondary ethoxylated alcohols and |
| | polyethylene oxide) |
| Formulation | 2,500 ppm quaternary disinfectant (demineralized water, octyl decyl |
| Sample No. 4 | dimethyl ammonium chloride, and dioctyl dimethyl ammonium |
| | chloride) + 1,250 ppm surfactant (secondary ethoxylated alcohols and |
| | polyethylene oxide) |
| Formulation | 2,500 ppm quaternary disinfectant (demineralized water, octyl decyl |
| Sample No. 5 | dimethyl ammonium chloride, and dioctyl dimethyl ammonium |
| | chloride) + 2,500 ppm surfactant (secondary ethoxylated alcohols and |
| | polyethylene oxide) |
| Formulation | 2,500 ppm quaternary disinfectant (demineralized water, octyl decyl |
| Sample No. 6 | dimethyl ammonium chloride, and dioctyl dimethyl ammonium |
| | chloride) + 2,500 ppm surfactant (secondary ethoxylated alcohols and |
| | polyethylene oxide) + 2,500 ppm Chelating agent (MGDA-Na3- |
| | trisodium salt of Methylglycinediacetic acid (Alanine, N,N- |
| | bis(carboxymethyl)-, sodium salt (1:3))) |
| Formulation | 2,500 ppm quaternary disinfectant (demineralized water, octyl decyl |
| Sample No. 7 | dimethyl ammonium chloride, and dioctyl dimethyl ammonium |
| | chloride) + 2,500 ppm surfactant (secondary ethoxylated alcohols and |
| | polyethylene oxide) + 2,500 ppm polypropylene glycol |
| Formulation | 625 ppm quaternary disinfectant (demineralized water, octyl decyl |
| Sample No. 8 | dimethyl ammonium chloride, and dioctyl dimethyl ammonium |
| | chloride) |
| Formulation | 2,500 ppm quaternary disinfectant (demineralized water, octyl decyl |
| Sample No. 9 | dimethyl ammonium chloride, and dioctyl dimethyl ammonium |
| | chloride) |

Comparative Sample No. 1 is a QAC containing product which is commercially available from Dr. Schumacher. Comparative Sample No. 1, in a 100 g of the solution, contained 2,500 ppm didecyl dimethyl ammonium chloride and 5,000 ppm alkyl (C12-16) dimethyl benzyl ammonium chloride.

The above formulations were then evaluated for antimicrobial efficacy as well as gloss, haze, and cleaning properties.

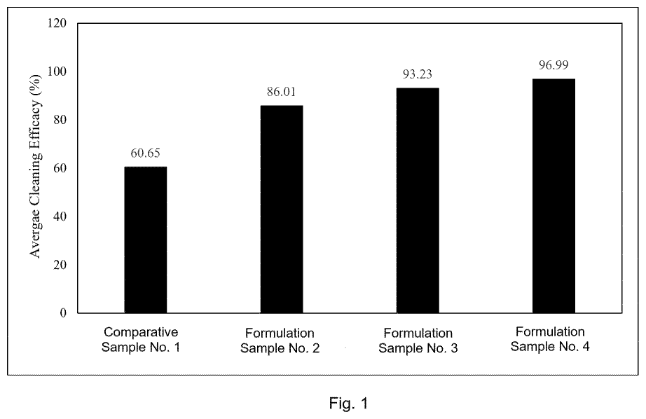

FIG. 1 indicates that a disinfectant composition according to Formulation Sample No. 2 showed an average cleaning efficacy of 86.01%, a disinfectant composition comprising Formulation Sample No. 3 showed an average cleaning efficacy of 93.23%, and a disinfectant composition comprising Formulation Sample No. 4 showed an average cleaning efficacy of 96.99%, as compared to Comparative Sample No. 1 which showed an average efficiency of 60.65%.

Cleaning efficacy is assessed by quantifying the stain removal on a white ceramic, non-porous surface after application of a formulation. A colourimeter (X-Rite Spectrophotometer) is used to measure the colour of a stain before and after treatment with a disinfectant cleaner. A scrub tester is used to treat the surface with the designated formulation in a consistent fashion. The greater the change in colour measured of the soiled/stained surface after treatment, the better the cleaning efficacy of the formulation. The colourimeter uses the L*a*b* colour space for the colour measurements in this method. The overall colour change in the L*a*b* values is described by a value known as ΔE, which is calculated from the change in L*, a* and b* values using the equation ΔE=[(Δl)2+(Δa)2+(Δb)2]1/2. The average cleaning efficacy % is calculated by comparing the ΔE between the stain colour before cleaning, stain colour after cleaning, and the baseline colour of the surface on which the stain is adhered to.

The inventors of the present disclosure have surprisingly found that low levels of QAC, as detailed above, can offer antimicrobial efficacy against bacteria, yeast, and enveloped viruses, along with cleaning properties, on hard surfaces. What is significant is that the composition of the present disclosure is better than a competitive QAC product of Comparative Sample No. 1. The Formulation Sample Nos. 2-4 which feature QAC concentrations that are lower than the QAC concentration present in the Comparative Sample No. 1 obtained better antimicrobial cleaning efficacy.

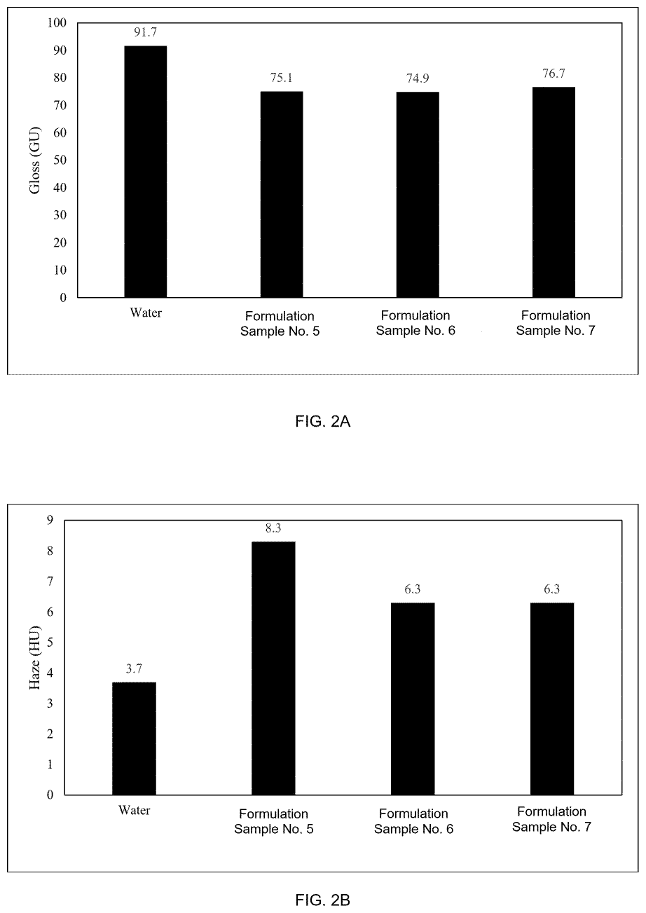

FIG. 2A depicts an average gloss, measured at 20°, for each formulation tested. The inventors have surprisingly found that neither the addition of a chelating agent in Formulation Sample No. 6 nor the addition of polypropylene glycol in Formulation Sample No. 7, had a negative effect on gloss. A glossmeter (Elcometer 480T was used in this study) is used to provide a quantitative measure of gloss and haze of a surface after application and drying of a formulation. Gloss is the visual sensation associated with the brightness of direct light reflected in a surface. Glossmeters quantify this effect by measuring light reflection from a sample at defined angles. On highly reflective surfaces, gloss is measured using the 20° angle on the glossmeter, in GU units. Haze describes the halo or bloom seen on the surface of high gloss finishes, and is measured in HU units. These measured values are used to interpret the level of streaking or residue left behind on a surface after treatment with a disinfectant cleaner. The higher the value of gloss, and the lower the value of haze, the less residue or streaks present on the hard surface.

FIG. 2B indicates an average haze. The inventors have surprisingly found that the addition of a chelating agent in Formulation Sample No. 6 or the addition of polypropylene glycol in Formulation Sample No. 7, was found to have a positive effect on haze. The testing method is as described under FIG. 2A above.

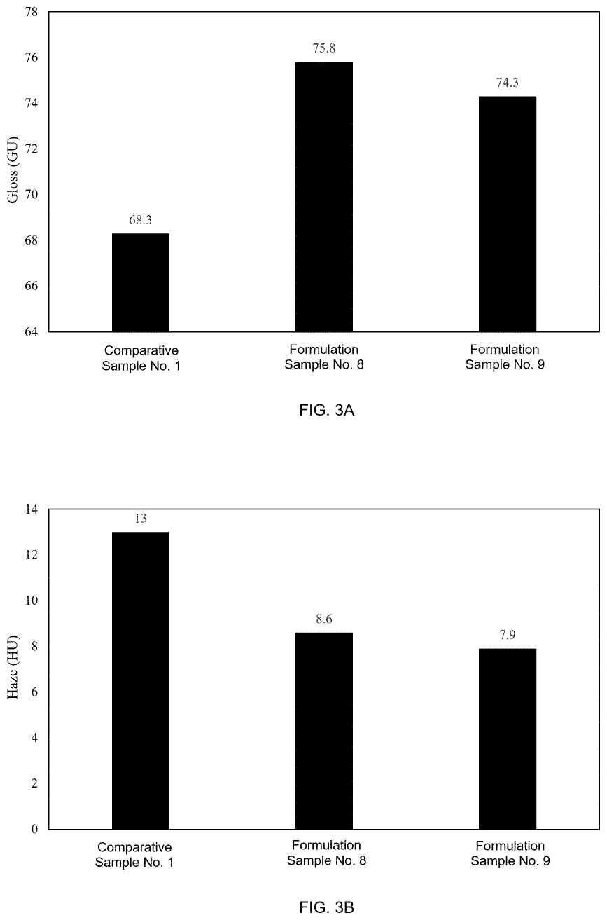

FIG. 3A shows streaking comparisons of the present disinfectant compositions as compared to the Comparative Sample No. 1. Formulation Sample Nos. 8-9 significantly outperformed the Comparative Sample. The testing method is as described under FIG. 2A above.

FIG. 3B shows streaking comparison of the present disinfectant composition as compared to Comparative Sample No. 1. Formulation Sample Nos. 8-9 significantly outperformed the Comparative Sample. The testing method is as described under FIG. 2A above.

### Example No. 2

A composition was formulated in accordance with the present disclosure as follows:

TABLE 2
Formulation including active levels in disinfectant composition.

| | | Inclusion | Inclusion | |
|---|---|---|---|---|
| | Active | Level as | Level as | |
| Ingredient | Level | 100% / % | Received / % | CAS No. |
| Water | 100 | | 99.362 | |
| Octyl Decyl | 32 | 0.100 | 0.125 | 32426-11-2 |
| Dimethyl | | | | |
| Ammonium Chloride | | | | |
| Dioctyl Dimethyl | 12.8 | 0.04 | 0.05 | 5538-94-3 |
| Ammonium Chloride | | | | |
| Didecyl Dimethyl | 19.2 | 0.06 | 0.075 | 7173-51-5 |
| Ammonium Chloride | | | | |
| Ethanol | 8 | 0.025 | 0.03125 | 64-17-5 |
| Alcohols C12-14 | 95 | 0.12375 | 0.13068 | 084133-50-6 |
| secondary | | | | |
| ethoxylated | | | | |
| Poly(ethylene oxide) | 95 | 0.00375 | 0.00396 | 68441-17-8 |
| Trisodium | 100 | 0.00025 | 0.00025 | 5064-31-3 |
| Nitrilotriacetate | | | | |
| 32% HCl | 100 | 0.032 | 0.1 | 7647-01-0 |

The above composition was applied to the following wipe samples and tested.

TABLE 3
Wipe Samples.

| | Basis | | |
|---|---|---|---|
| | Weight | | |
| Wipe Sample No. | (gsm) | Structure | Composition |
| Wipe Sample No. 1 | 48 | Flat | 100% PET |
| Wipe Sample No. 2 | 50 | Flat | 100% PET |
| Wipe Sample No. 3 | 50 | Fine Aperture | 100% PET |
| Wipe Sample No. 4 | 51 | Flat | 50.4% WP/49.6% PET |
| Wipe Sample No. 5 | 48 | Flat | 100% PET |
| Wipe Sample No. 6 | 60 | Flat | 100% PET |
| Wipe Sample No. 7 | 50 | Fine Aperture | 100% PET |
| Wipe Sample No. 8 | 60 | Fine Aperture | 100% PET |
| Wipe Sample No. 9 | 41 | Flat | 100% PET |
| Wipe Sample No. 10 | 54 | Flat | 100% PET |
| Wipe Sample No. 11 | 68 | Flat | 100% PET |
| Wipe Sample No. 12 | 45 | Fine Aperture | 100% PET |
| Wipe Sample No. 13 | 51 | Flat | 54% WP/ 46% PET |
| Wipe Sample No. 14 | propri- | proprietary | proprietary |
| | etary | | |

The formulations, as detailed above, were then evaluated for antimicrobial efficacy in the form of a wiping product. In particular, the formulations were tested according to Test EN 16615. The formulations were tested on a hard surface against Staphylococcus aureus. Apertured wipes, generally, released more liquid.

In Table 4, micro efficiency data from EN16615 test carried out in medical dirty conditions is provided. Wipe Sample No. 14 saturated with 2,500 ppm of QAC gives 100% kill efficiency against all organisms tested.

TABLE 4
Micro efficiency data.

| | Wipe Sample No. 14, EN16615 Percentage |
|---|---|
| Microorganism | Pass Rate (n = 2) |
| Pseudomonas aeruginosa | 100% |
| Staphylococcus aureus | 100% |
| Escherichia coli | 100% |
| Enterococcus hirae | 100% |
| Candida albicans | 100% |

As shown above, samples tested passed the EN16615 test at a 100% against all microorganisms tested.

In the experiments to test micro efficacy, four wipe samples were selected, two of which were flat structured and two of which were fine apertured (but not necessarily the same on other properties). It was observed that Wipe Sample No. 3 and Wipe Sample No. 12 performed the best out of the wipes tested in the micro efficacy test (EN 16615). Such effect was especially noticeable at lower dosing ratios.

Micro efficiency results were tested using the EN16615 test. The results were generated in dirty conditions versus Staphylococcus aureus. Table 5 indicates that primary alcohol ethoxylate surfactant can give a lower pass rate than secondary alcohol ethoxylates.

TABLE 5
micro efficiency results from the EN16615 test.

| | | Dosing | Average Log | Pass |
|---|---|---|---|---|
| | Surfactant | Ratio | Reduction | Percentage |
| Primary | C12-C13 Alcohol | 4.5x | 5.13 | 40% |
| Alcohol | Ethoxylate with 7 | | | |
| Ethoxylate | Moles Ethylene | | | |
| | Oxide | | | |
| Secondary | Alcohols, C12-14- | 4.5x | 5.79 | 100% |
| Alcohol | secondary, | | | |
| Ethoxylate | ethoxylated | | | |
| | (>97.0%); | | | |
| | Poly(ethylene oxide) | | | |
| | (<3.0%); | | | |
| | Alcohols, C12-14- | | | |
| | secondary (<2.0%) | | | |
| | [Tergitol 15 S-5] | | | |
| | Alcohols, C12-14- | 4.5x | 5.53 | 80% |
| | secondary, | | | |
| | ethoxylated | | | |
| | (>=97.0%); | | | |
| | Poly(ethylene oxide) | | | |
| | (<=3.0%) | | | |
| | [Tergitol 15 S-7] | | | |
| | Alcohols, C12-14- | 4.5x | 5.56 | 80% |
| | secondary, | | | |
| | ethoxylated | | | |
| | (>=97.0%); | | | |
| | Poly(ethylene oxide) | | | |
| | (<=3.0%) | | | |
| | [Tergitol 15 S-9] | | | |

As shown above, low QAC levels can be used to arrive at an efficacious disinfectant composition.

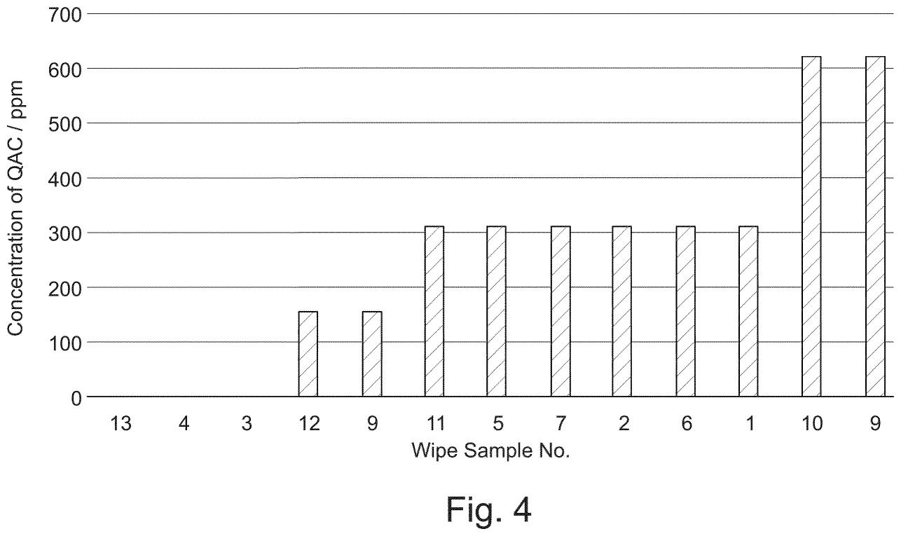

FIG. 4 shows minimum concentration of QAC absorbed by various wipes. Lowest amount of QAC was associated with Wipes Sample No. 13, Wipes Sample No. Wipes Sample No. 4.

In Table 6, average log reduction for each dosing ratio tested is provided.

TABLE 6
Average log reduction.

| | Dosing | Average Log | |
|---|---|---|---|
| Wipe Sample | Ratio | Reduction | Pass percentage |
| Wipe Sample No. 3 | 4.5x | 5.99 | 100% |
| | 3.5x | 5.82 | 100% |
| | 2.5x | 5.15 | 60% |
| Wipe Sample No. 5 | 4.5x | 6.21 | 100% |
| | 3.5x | 5.26 | 40% |
| | 2.5x | 4.63 | 20% |
| Wipe Sample No. 9 | 4.5x | 6.37 | 100% |
| | 3.5x | 5.97 | 100% |
| | 2.5x | 5.59 | 80% |
| Wipe Sample No. 12 | 4.5x | 6.33 | 100% |
| | 3.5x | 5.20 | 60% |
| | 2.5x | 4.81 | 40% |

As shown above, it was unexpectedly discovered that the disinfectant composition of the present disclosure was an average log reduction of at least 4.63 log reduction in all wipe samples tested. The contract time tested was at 60 seconds. The present composition can be used on both types of wipes, flat and apertured, and good results can still be achieved.

As shown above, dramatic and unexpected antimicrobial efficacy was demonstrated while still maintaining low haze and high gloss values when a combination of a QAC with a surfactant in accordance with the present disclosure was tested. In the present disclosure, a disinfectant composition with a low level of QAC showed antimicrobial efficacy while still passing EN16615 and EN 13727 against bacteria and yeast, with a contact time of 1 minute (60 seconds) under dirty medical and dirty I&I conditions as well as modified EN16615 against viruses under dirty medical and dirty I&I conditions. The present disinfectant composition was found to be efficacious on hard surfaces. The present disinfectant composition was found to be efficacious in a form of, for example, wipes which provide for cleaning benefits with minimal streaking effects.

These and other modifications and variations to the present invention may be practiced by those of ordinary skill in the art, without departing from the spirit and scope of the present invention, which is more particularly set forth in the appended claims. In addition, it should be understood that aspects of the various aspects may be interchanged both in whole or in part. Furthermore, those of ordinary skill in the art will appreciate that the foregoing description is by way of example only and is not intended to limit the invention so further described in such appended claims.

What is claimed:

1. A disinfectant composition that may be a ready to use solution or a liquid concentrate comprising:
an antimicrobial agent comprising a quaternary ammonium compound or a mixture of quaternary ammonium compounds, the antimicrobial agent being present in the ready to use solution in an amount less than about 10,000 ppm;
a surfactant comprising an ethoxylated secondary alcohol or a mixture of ethoxylated secondary alcohols, the surfactant being present in the composition in relation to the antimicrobial agent at a weight ratio of from about 1:5 to about 5:1; and
wherein the surfactant is the only nonionic surfactant contained in the composition.

2. A disinfectant composition as defined in claim 1, wherein the liquid concentrate is fifty times more concentrated than the ready to use solution and contains the antimicrobial agent in an amount less than about 125,000 ppm.

3. A disinfectant composition as defined in claim 1, wherein the composition further includes a polypropylene glycol.

4. A disinfectant composition as defined in claim 1, wherein the antimicrobial agent is present in the ready to use solution in an amount of about 2,500 ppm and the surfactant is present in the composition in relation to the antimicrobial agent at a weight ratio of about 1:1.

5. A disinfectant composition as defined in claim 1, wherein the composition does not contain any other antimicrobial agents.

6. A disinfectant composition as defined in claim 1, further comprising a chelating agent, wherein the chelating agent comprises methylglycinediacetic acid.

7. A disinfectant composition as defined in claim 1, further containing a pH adjusting agent, the pH adjusting agent comprising an acid, wherein the acid comprises hydrochloric acid, and wherein the pH is adjusted between about pH6 to about pH8.

8. A disinfectant composition as defined in claim 1, wherein the ethoxylated secondary alcohol contains a carbon chain having a carbon chain length of from about C₆ to about C₆₀, and wherein the ethoxylated secondary alcohol contains from about 2 moles to about 16 moles of ethylene oxide per mole of alcohol.

9. A disinfectant composition as defined in claim 8, wherein the secondary alcohol contained in the ethoxylated secondary alcohol is unbranched.

10. A disinfectant composition as defined in claim 1, wherein the antimicrobial agent is present in the composition in an amount from about 500 ppm to about 4,000 ppm, the surfactant being present in an amount from about 750 ppm to about 1,800 ppm, the disinfectant composition further containing a chelating agent in an amount from about 800 ppm to about 3,500 ppm and a pH adjusting agent comprising an acid present in the composition in an amount from about 50 ppm to about 500 ppm, the remainder of the disinfectant composition comprising water.

11. A disinfectant composition as defined in claim 1, wherein the disinfectant composition demonstrates at least a 5 log reduction when tested against Staphylococcus aureus, Enterococcus hirae, or Pseudomonas aeruginosa according to Test EN 16615 for a contact time of 60 seconds, at least a 4 log reduction when tested against Candida albicans according to Test EN 16615 for a contact time of 60 seconds, or at least a 4 log reduction when tested against Vaccinia virus according to a modified Test EN 16615 for a contact time of 60 seconds.

12. A disinfectant composition as defined in claim 1, wherein the at least one quaternary ammonium compound comprises at least one dimethyl dialkyl ammonium chloride.

13. A premoistened wiping product comprising:
a liquid absorbent substrate; and
a disinfectant composition contained within the substrate, the disinfectant composition as defined in claim 1.

14. A premoistened wiping product as defined in claim 13, wherein the liquid absorbent substrate comprises a nonwoven web, the nonwoven web comprising a meltblown web, a coform web, a spunbond web, an airlaid web, an airlaced web, a hydroentangled web, a bonded carded web, or a laminate thereof, and wherein the liquid absorbent substrate is optionally apertured.

15. A method for destroying microorganisms on an adjacent surface comprising:
saturating a liquid absorbent substrate with a disinfectant composition, the disinfectant composition as defined in claim 1; and
applying the saturated liquid absorbent substrate to a hard surface.

16. A disinfectant composition as defined in claim 1, wherein the antimicrobial agent is present in the ready to use solution in an amount less than about 3,000 ppm.

17. A disinfectant composition as defined in claim 1, wherein the surfactant is present in the composition in relation to the antimicrobial agent at a weight ratio of from about 0.75:1 to about 1:0.75.

18. A disinfectant composition as defined in claim 1, wherein the liquid concentrate is five times more concentrated than the ready to use solution and contains the antimicrobial agent in an amount less than about 12,500 ppm.

19. A disinfectant composition as defined in claim 1, wherein the ethoxylated secondary alcohol contains a carbon chain having a carbon chain length of from about C₁₀ to about C₃₂ and wherein the ethoxylated secondary alcohol contains from about 3 moles to about 12 moles of ethylene oxide per mole of alcohol.

20. A disinfectant composition as defined in claim 1, wherein the at least one quaternary ammonium compound comprises didecyl dimethyl ammonium chloride, octyl decyl dimethyl ammonium chloride, dioctyl dimethyl ammonium chloride, and mixtures thereof.
